(19) United States
(12) Patent Application Publication
(10) Pub. No.: US 2005/0013247 A1
(43) Pub. Date: Jan. 20, 2005

(54) Method for controlling data transmission, and data transmission system

(76) Inventors: Jussi Sipola, Oulu (FI); Frederic Noel, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/902,420

(22) Filed: Jul. 30, 2004

Related U.S. Application Data
(63) Continuation of application No. PCT/FI02/00107, filed on Feb. 12, 2002.

(51) Int. Cl. H04Q 7/00; H04L 12/26; H04J 3/14

(52) U.S. Cl. 370/230; 370/431; 370/329

(57) ABSTRACT

The invention relates to a method for controlling data transmission in a communication system transmitting data in packet format between a first (142, 162) and a second (170) transceiver on at least one physical channel. To transmit data blocks between the first and the second transceiver, at least one logical connection is established, each logical connection using ARQ error correction and a related transmission window. The number of logical connections is selected on the basis of the number of data blocks per unit of time, which can be transmitted between the first and the second transceiver.

### FIELD

The invention relates to a method for controlling data transmission in a communication system in which data is transmitted in packet format on at least one channel divided into time slots and which uses ARQ error correction.

### BACKGROUND

Most radio systems that are intended for general use are based on a circuit-switched technique. Systems implemented according to this technique reserve fixed communication resources for the duration of a connection regardless of the occurrence of traffic. For systems transmitting mainly speech, this solution is sufficient. In addition to speech transmission non-speech data transmission is gradually increasing. Traffic transmitted on data links is often burst-like, i.e. at times, a lot of data is transmitted and the transmission capacity requirement of the channel is high, and at times, the channel has very little traffic. For such connections, packet-switched connections are a very good solution in terms of capacity use. In packet-switched connections, the channel is not reserved for the duration of the connection for the terminals but only when there is a need for data transmission. Thus, various radio systems utilizing packet transmission have been developed, in which at least a part of the connections between terminals is established using a packet protocol. These systems include GPRS (General Packet Radio System) and its successor EGPRS (Enhanced General Packet Radio System).

The aim in data communication is to ensure the success of data transmission between transceivers. In digital data transmission, backward error correction is often used, in which transmission errors are notified to the sender who then retransmits the erroneous data. One known method is Selective Reject ARQ (Automatic Repeat reQuest), in which a transmitter transmits data blocks to a receiver. The receiver acknowledges the received blocks, and the transmitter receives in this manner information on successfully or unsuccessfully received blocks. The transmitter can retransmit the blocks whose reception failed. The transmitter can transmit a certain number of data blocks to the receiver without receiving any acknowledgement. When an acknowledgement is received, more data blocks are transmitted. The set of data blocks that the transmitter can consecutively transmit without acknowledgement is called a transmit window in this protocol. Correspondingly, the receiver maintains a separate window for received data blocks. This is called a receive window. These windows can be commonly referred to as transmission windows.

Because there are different data services and they have different data transmission requirements, many systems provide an opportunity to set up connections having different capacities. Further, many systems use different terminals whose data transmission properties and possibilities to utilize the resources of the system are very different. For instance, the equipment and the data transmission capacities required for transmitting speech, text, and video images are different. Data transmission rates higher than the present ones will be needed in the future due to new data services.

Data rates can be increased for instance by introducing more efficient modulation methods. However, this causes problems on higher protocol layers. Data transmission systems are designed in line with known OSI protocol layers. In the EGPRS system, for instance, the lowest protocol layer is a physical layer that includes the modulation methods. Above it, there is an RLC/MAC (Radio Link Control/Medium Access Layer) layer, and above this, a PDCP (Packet Data Convergence Protocol) layer. These are described in more detail later. In the EGPRS system, for instance, radio protocols are designed in such a manner that the highest possible data rate is achieved by using eight time slots and an MCS-9 modulation type. Each data transmission connection is established by setting up a TBF (Temporary Block Flow) connection between a transmitter and receiver in the MAC layer. TBF is a logical unidirectional connection that supports data transmission on one or more physical packet data channels. RLC blocks are transmitted using TBF. RLC blocks are transmitted in the physical layer by means of radio blocks. TBF is identified by an information element, TFI (Temporary Flow Identifier). Selective Reject ARQ error correction is used inside TBF. The blocks to be transmitted are numbered by sequential numbers. In the EGPRS system, the block numbers are 11-bit numbers, so the block number space is 2048. Due to the properties of Selective Reject ARQ, the transmission window can be at most half of the size of the block number space, so the size of the transmission window in one TBF is limited to 1024 RLC blocks in the error correction of the EGPRS RLC protocol. This transmission window enables a transmission rate of 800 RLC blocks per second, which in turn corresponds to a user data block rate of two RLC blocks per one radio block with eight time slots. The size of the transmission window is selected based on the number of the time slots (which can be 1 to 8) reserved for transmission as shown in the table of FIG. 1.

As a result of too small a transmission window, the protocol cannot transmit data blocks fast enough and performance becomes poorer. Too big a transmission window in turn weakens performance because the need for memory increases. It is thus important for performance that the transmission window is exactly the right size. Since window sizes larger than half the block number space are not possible, the current RLC/MAC layer does not enable support for new services using a high data block rate.

### BRIEF DESCRIPTION OF THE INVENTION

It is an object of the invention to provide a method and a data transmission system which support both high and low data rates efficiently. This is achieved by a method for controlling data transmission in a communication system transmitting data in packet format between a first and a second transceiver on at least one physical channel, establishing at least one logical connection for transmitting data blocks between the first and the second transceiver, each logical connection using ARQ error correction and a related transmission window and selecting the number of logical connections on the basis of the number of data blocks that can be transmitted between the first and the second transceiver per unit of time.

The invention also relates to data transmission communication system that comprises a first and a second transceiver, between which data is transmitted in packet format on at least one physical radio channel, and which system is arranged to establish at least one logical connection for transmitting data blocks between the first and the second transceiver, where each logical connection uses ARQ error correction and a related transmission window, and to select the number of logical connections on the basis of the number of data blocks that can be transmitted between the first and the second transceiver per unit of time.

Preferred embodiments of the invention are described in the dependent claims.

The preferred embodiments of the invention thus define the number of time slots required for transmitting packets, the number being dependent on the desired data transmission rate. The required size of the transmission window of the error correction used in packet transmission and the number of logical connections are then selected on the basis of the number of time slots reserved for packet transmission and the used data block rate.

When applying the preferred embodiments of the invention to the EGPRS system, the logical connection is TBF.

The number of TBFs to be used in transmitting packets is selected on the basis of the required size of the transmission window. If the required size of the transmission window is larger than that allowed for one TBF, more than one TBF is selected.

The length of the propagation delay of the signal between the first and the second transceiver, error correction parameters, the ability of the first or the second transceiver to process several logical connections and different sizes of the transmission window, or the division of time slots between different transceiver connections may affect the size of the transmission window and the number of TBFs in the preferred embodiments.

If time slots are reserved from more than one frequency for data transmission between the first and the second transceiver, the time slots of different frequencies belong to the same logical connection in one preferred embodiment. In a second preferred embodiment, the time slots of different frequencies belong to different logical connections.

The method and system of the invention provide several advantages. By means of the solution, it is possible to flexibly support both high and low data rates efficiently. The size of the transmission window required by ARQ error correction can be flexibly selected to be the correct one. Further, by means of the solution, a minimum number of TBFs can be selected for a connection, thus reducing signalling and the decrease in performance due to a large number of TBFs. Using several TBFs requires more multiplexing of data blocks, which also decreases performance. The ability of terminals to process numerous TBFs is also limited.

Earlier, the size of the transmission window was determined on the basis of the dedicated resources. In packet transmission, however, several users share the same resources. In a solution of one embodiment, the distribution of resources can be taken into account when selecting the size of the transmission window.

### BRIEF DESCRIPTION OF THE FIGURES

The invention will now be described in greater detail by means of preferred embodiments and with reference to the attached drawings, in which

FIG. 1 shows the table already described above illustrating the dependency of the size of the transmission window on the number of time slots reserved for the connection,

FIG. 2 shows an example of a system to which the invention can be applied,

FIG. 3 illustrates protocol stacks,

FIGS. 4A to 4C illustrate an ARQ transmission window,

FIG. 5 shows an RLC/MAC block,

FIG. 6 shows a block diagram of an embodiment,

FIGS. 7A and 7B illustrate an example of selecting TBFs,

FIGS. 8A and 8B illustrate an example of an embodiment,

FIGS. 9A to 9C illustrate an example of an embodiment, and

FIG. 10 shows an example of a transceiver.

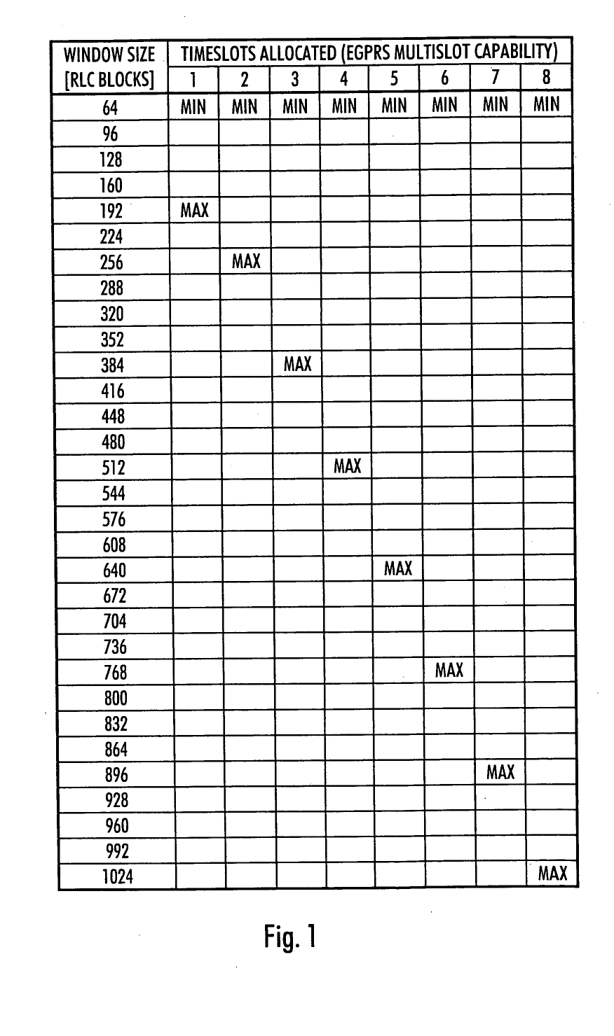

### DETAILED DESCRIPTION OF THE INVENTION

The invention is preferably applied to systems employing packet-format data transmission that also use ARQ-based error correction. Examples of such radio systems include EGPRS and UMTS. EGPRS (Enhanced General Packet Radio Service) is a GSM-based (Global System for Mobile Communications) system utilizing packet-switched transmission. EGPRS uses the EDGE (Enhanced Data Rates for GSM Evolution) technique for increasing the data transmission capacity. UMTS (Universal Mobile Telecommunication System) is a third-generation transmission system. In the following, the preferred embodiments are described using these two systems, EGPRS and UMTS, as examples, without limiting the invention to them, as is apparent to a person skilled in the art.

Let us now specify to some extent the terminology used in the application. In this context, a radio system refers to the Radio Access Technology RAT of telecommunications systems that belongs to what is known as the Access Stratum, above which there is a Non Access Stratum NAS that uses the services of separate radio systems.

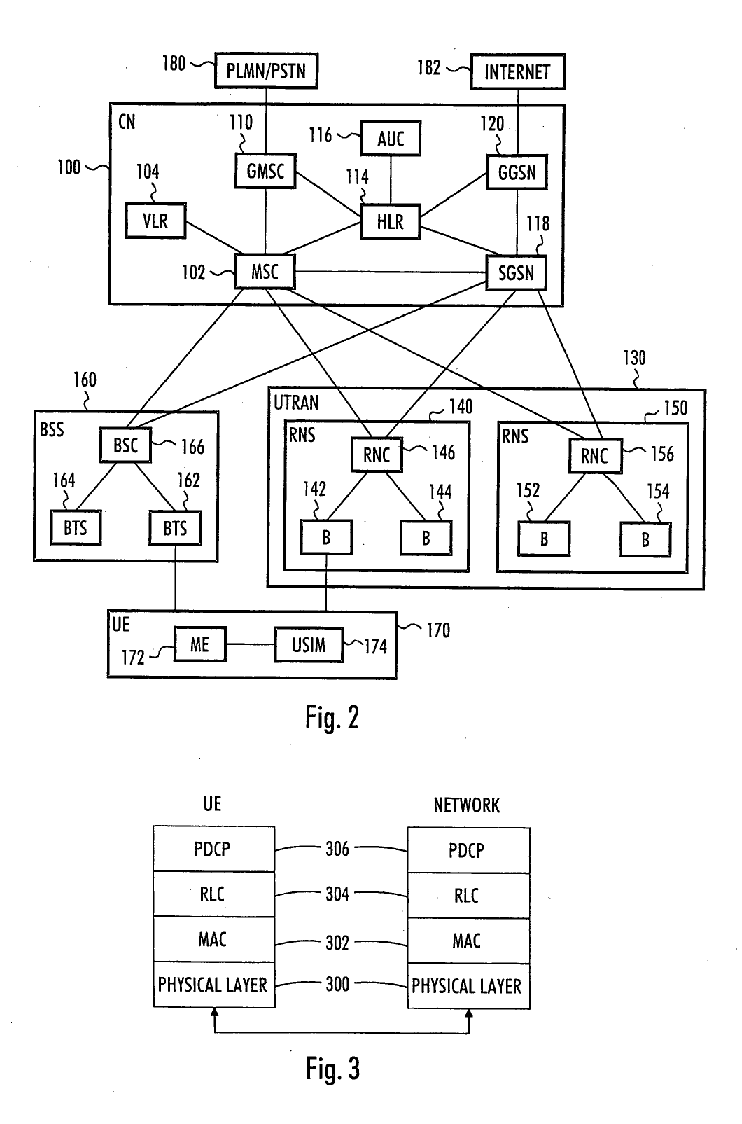

Let us now examine FIG. 2 that both clarifies the used terminology and illustrates the structure of the radio systems. FIG. 2 is a simplified block diagram that describes on network-element level the most important parts of the radio systems. The structure and functions of the network elements are not described in detail, because they are commonly known.

In FIG. 2, a core network CN 100 represents the radio-independent layer of the telecommunications system. The radio systems are shown as a first radio system, i.e. radio access network 130, and a second radio system, i.e. base station system BSS 160. In addition, the figure shows user equipment UE 170. The term UTRAN comes from the words UMTS Terrestrial Radio Access Network, i.e. the radio access network 130 is implemented using wideband code division multiple access WCDMA. The base station system 160 is implemented using time division multiple access TDMA.

Generally, it is also possible to define that a radio system comprises user equipment, also known as user device and mobile phone, and a network part that contains the radio access network or base station system of the fixed infrastructure of the radio system.

The structure of the core network 100 corresponds to a combined GSM and GPRS system structure. The GSM network elements are responsible for providing circuit-switched connections and the GPRS network elements are responsible for providing the packet-switched connections, some of the network elements are, however, included in both systems.

A mobile services switching centre MSC 102 is the midpoint of the circuit-switched side of the core network 100. One and the same mobile services switching centre 102 can be used to serve the connections of both the radio access network 130 and the base station system 160. The tasks of the mobile services switching centre 102 include switching, paging, location registration, handover management, collecting subscriber billing information, encryption parameter management, frequency allocation management, and echo cancellation. The number of mobile services switching centres 102 may vary: a small network operator may have only one mobile services switching centre 102, but large core networks 100 usually have several.

Large core networks 100 can have a separate gateway mobile services switching centre GMSC 110 that takes care of the circuit-switched connections between the core network 100 and external networks 180. The gateway mobile services switching centre 110 is located between the mobile services switching centres 102 and the external networks 180. An external network 180 can be a public land mobile network PLMN or public switched telephone network PSTN, for instance.

A home location register HLR 114 contains a permanent subscriber register, i.e. the following information, for instance: an international mobile subscriber identity IMSI, mobile subscriber ISDN number MSISDN, authentication key, and when the radio system supports GPRS, a PDP (Packet Data Protocol) address.

A visitor location register VLR 104 contains user equipment 170 roaming information in the area of the mobile services switching centre 102. The visitor location register 104 contains mainly the same information as the home location register 114, but the information is only temporarily in the visitor location register 104.

An authentication centre AuC 116 always resides physically at the same location as the home location register 114 and contains an individual subscriber authentication key Ki, ciphering key CK and the corresponding IMSI.

The network elements in FIG. 2 are functional entities whose physical implementation may vary. Ordinarily, the mobile services switching centre 102 and visitor location register 104 form one physical device, and the home location register 114 and authentication centre 116 a second physical device.

A serving GPRS support node SGSN 118 is the midpoint of the packet-switched side of the core network 100. The main task of SGSN 118 is to transmit packets to and receive them from user equipment 170 supporting packet-switched transmission by using the radio access network 130 or base station system 160. SGSN 118 contains subscriber and location information concerning the user equipment 170.

A gateway GPRS Support Node GGSN 120 is the packet-switched side counterpart to the gateway mobile services switching centre 110 of the circuit-switched side, with the difference, however, that GGSN 120 must also be capable of routing traffic from the core network 100 to external networks 182, whereas GMSC 110 only routes incoming traffic. In our example, the Internet represents the external networks 182.

The first radio system, i.e. radio access network 130, comprises radio network subsystems RNS 140, 150. Each radio network subsystem 140, 150 comprises radio network controllers RNC 146, 156 and Nodes B 142, 144, 152, 154. The Node B is a rather abstract concept, and often the term base station is used instead of it.

The radio network controller 146 controls the Nodes B 142, 144 under it. In principle, the aim is that the devices providing the radio path and the related functions reside in the Nodes B 142, 144 and the control devices reside in the radio network controller 146.

The radio network controller 146 takes care of the following tasks, for instance: radio resource management of the Node B 142, 144, intercell handovers, frequency management, i.e. the allocation of frequencies to the Nodes B 142, 144, management of frequency hopping sequences, measurement of time delays on the uplink, provision of the operation and maintenance interface, and power control.

The node B 142, 144 comprises one or more transceivers, with which the WDCMA radio interface is provided. The Node B serves one cell, but it can also serve several sectored cells. The diameter of a cell can vary from a few metres to dozens of kilometres. The tasks of the Node B 142, 144 include: timing advance calculation, uplink measurements, channel coding, encryption and decryption.

The second radio system, i.e. base station system 160, comprises a base station controller BSC 166 and base stations BTS 162, 164. The base station controller 166 controls the base stations 162, 164. In principle, the aim is that the devices providing the radio path and the related functions reside in the base stations 162, 164 and the control devices reside in the base station controller 166. The base station controller 166 takes care of essentially the same tasks as the radio network controller.

The base station 162, 164 contains at least one transceiver that provides one carrier, i.e. eight time slots, i.e. eight physical channels. Typically, one base station 162, 164 serves one cell, but it can also serve several sectored cells. The base station 162, 164 also comprises a transcoder that converts between the speech coding formats used in the radio system and the public telephone network. However, in practice, the transcoder usually resides physically in the mobile services switching centre 102. The tasks of the base station 162, 164 correspond to those of the Node B.

The user equipment 170 comprises two parts: mobile equipment ME 172 and UMTS subscriber identity module USIM 174. The user equipment 170 contains at least one transceiver that provides a radio link to the radio access network 130 or base station system 160. The user equipment 170 can contain at least two different user identity modules. In addition, the user equipment 170 contains an antenna, user interface and a battery. Currently, there are different types of user equipment 170, those installed in cars and portable equipment, for instance.

USIM 174 contains user-related information and especially information related to information security, such as an encryption algorithm.

GPRS and EGPRS have a packet control unit PCU. The tasks of PCU include PDPC (Packet Data Convergence Protocol) block segmentation and reassembly, functions related to error correction (ARQ), packet data channel PDCH control, channel access control, and radio channel management. Physically PCU can be implemented in connection with the base station, radio network controller (base station controller) or SGSN.

FIG. 3 illustrates the lowest layers of protocol stacks used in a data transmission system according to a preferred embodiment on a connection between two transceivers; in this example, on a connection between user equipment and a network base station. Only the lowest, physical layers communicate with each other directly. Other layers always use the services provided by the next, lower layer. A signal must thus physically move vertically between layers, and only in the lowest layer does the signal move horizontally between layers. The lowest layer is thus a physical layer 300. The mechanical, electronic and functional properties for connecting to a physical transmission path are defined in the physical layer.

The upper layers use the services of the physical layer to provide reliable data transmission and to take care of transmission error correction, for instance.

The next layers are divided into a MAC layer 302, RLC layer 304 and PDCD layer 306. The RLC and MAC layers are also often shown as a combined RLC/MAC layer. The tasks of the RLC/MAC (Radio Link Control/Medium Access Control) layers are to take care of the segmentation, concatenation and reassembly of the data being transmitted and to perform the ARQ protocol procedures. In addition, the RLC layer hides the quality changes of the physical layer radio link from the upper layers. The MAC layer allocates and releases traffic channels to radio bearers. The task of the PDCD (Packet Data Convergence Protocol) layer is mainly to compress the header data of the IP packets of the user.

The packet-format data to be transmitted is in RLC blocks in the RLC layer. When there are RLC blocks to be transmitted from the network side to a terminal, the data transmission connection is established as a temporary block flow TBF in the MAC layer between a transmitter and receiver. TBF is a unidirectional connection that supports data transmission on one or more physical packet data channels PDCH. A radio resource is allocated to TBF on one or more PDCHs and it comprises RLC/MAC blocks that contain one or more upper-layer blocks. TBF is temporary in duration and it is maintained only during the transmission of the data (i.e. as long as there are RLC/MAC blocks to transmit that the recipient has not acknowledged as successfully received). The RLC blocks are transmitted in the physical layer by means of radio blocks. Each TBF is identified by an information element, TFI (Temporary Flow Identifier).

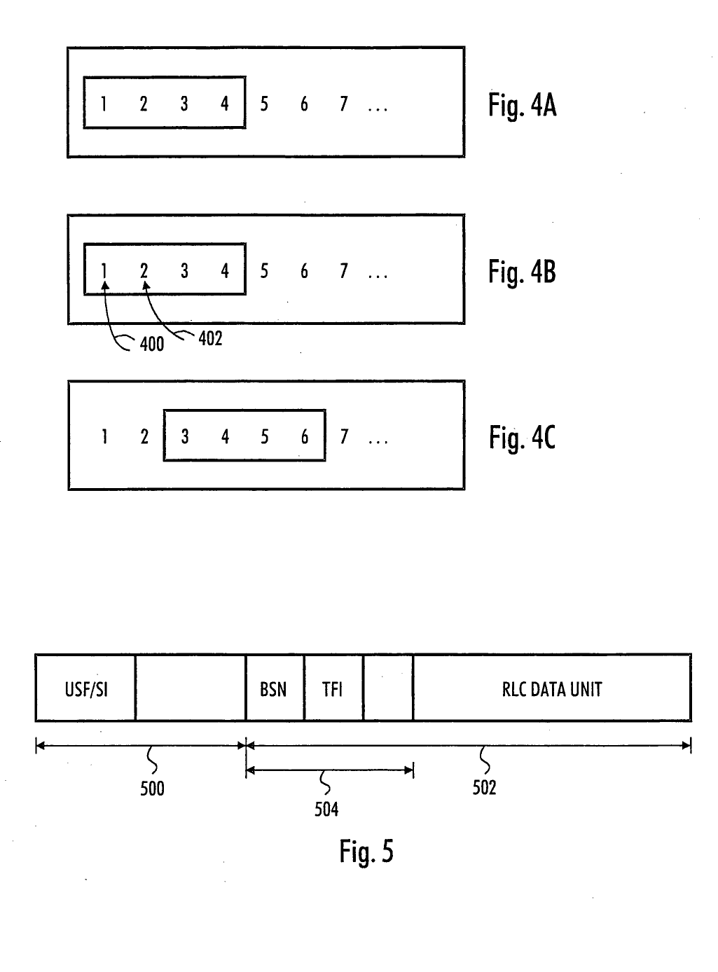

Selective Reject ARQ error correction is used inside each TBF. FIGS. 4A to 4C illustrate the transmission window used in connection with ARQ error correction. Let us assume herein that a transmitter transmits data blocks to a receiver and that the data blocks are numbered 1, 2, 3, . . . inside TBF. The set of data blocks that the transmitter can transmit consecutively without acknowledgement from the receiver is called a transmission window. In this example, the transmission window in the transmitter contains four blocks. As shown in FIG. 4A, the transmitter transmits the data blocks 1 to 4 inside the window to the receiver. The receiver sends an acknowledgement to the transmitter on the received data blocks. Let us assume herein that the receiver received blocks 1 and 2 successfully. The receiver sends acknowledgements 400 and 402 on this to the transmitter as shown in FIG. 4B. Now the transmitter can move the transmission window forward as shown in FIG. 4C.

Several types of acknowledgement methods are being used. In one alternative, the receiver sends information on successfully received blocks, in another alternative, information is sent on blocks whose reception failed. The type of acknowledgement is not significant to the present invention.

FIG. 5 illustrates an example of a possible RLC/MAC block. The block contains a MAC header 500 and RLC data block 502. The RLC data block in turn comprises an RLC header 504 having a BSN (Block Sequence Number) field that indicates the sequence of the RLC data blocks inside TBF. TFI in turn identifies which TBF the block belongs to. An RLC data unit comprises the information to be transmitted.

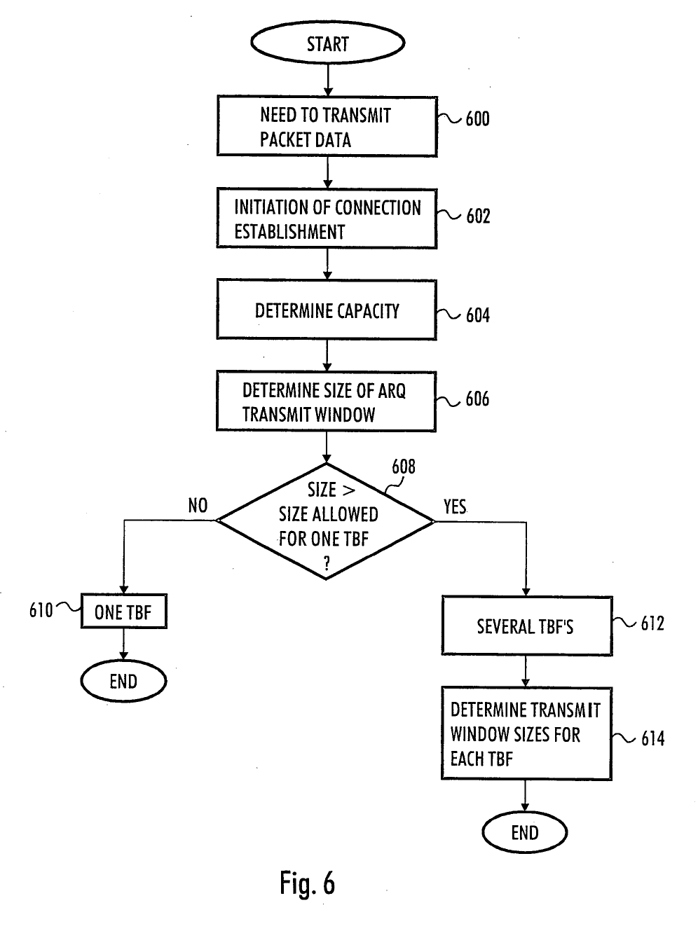

Let us now examine a solution of a preferred embodiment by means of the block diagram shown in FIG. 6. When there is a need 600 to transmit information in packet format between a terminal and network, connection establishment 602 first needs to be initiated for data transmission. When setting up packet data transmission, it is first necessary to define 604 the properties of the required connection that are determined on the basis of the amount of data to be transmitted and the desired transmission rate, for instance. If the desired transmission rate is high, the connection requires more physical resources, i.e. time slots, than a connection with a low data rate. In an EGPRS system, each frequency has eight time slots. One or more time slots on one or more frequencies can be allocated to a packet data connection. The desired transmission rate, the properties of the terminal and the load of the frequencies naturally affect the number of time slots to be defined for each connection and their location on different frequencies.

The number of time slots selected for a packet data connection and the used modulation and channel coding method determine the achieved data rate. The modulation method and channel coding determine how many RLC data blocks fit into one radio block. The size of the ARQ transmission window needed for a packet data connection is determined on the basis of this information. In a preferred embodiment of the invention, the required size of the transmission window is selected 606 on the basis of the number of time slots allocated to the transmission of packets and the used transmission rate of the RLC blocks. Next, a check is made 608 to see if the required size of the transmission window is larger than that allowed for one TBF connection. In the error correction of the EGPRS RLC protocol, the size of the transmission window used for TBF is limited to 1024 RLC blocks. If the window size is not larger than the allowed window size, one TBF 610 is enough for a connection. Meanwhile, if the size of the window is larger than that allowed for one TBF, more than one TBF is selected 612.

In the case of one TBF 610, the time slots allocated to it can be on one or more frequencies. In this solution, TBF resources are saved in comparison with a situation, in which the time slots on each frequency have their own TBF regardless of the number of time slots.

In the case of several TBFs 612, the time slots and the total size of the transmission window are divided between different TBFs. For this, there are various methods that are described later. The division should, however, be performed in such a manner that the transmission window allocated to one TBF is smaller than or equal to the largest allowed window size.

Different parameters can affect the number of TBFs and the size of the transmission window in the preferred embodiments. When making the decision the properties of the terminal can be taken into account. These properties include the ability to process several time slots and frequencies on the same connection, as well as the modulation methods supported by the terminal. The number of physical channels, i.e. time slots, to be used on different frequencies can affect the selection. Further, the selection is influenced by how many RLC blocks can be transmitted in each radio block. This depends on the used modulation and channel coding. The accompanying table illustrates the number of RLC blocks in different EGPRS modulation and channel coding methods (MCS, Modulation and Coding Scheme).

TABLE 1

| EGPRS MCS | RLC data blocks per radio block |
|---|---|
| MCS-1 . . . MCS-6 | 1 |
| MCS-7 . . . MCS-9 | 2 |
| MCSs having higher rates | ≧2 |

Another factor affecting the size of the transmission window and the number of TBFs is the length of the propagation delay of a signal between the transceivers that affects the propagation delay of the acknowledgements. Error correction parameters, such as the transmission frequency of acknowledgements, can be taken into account. In one embodiment, the division of resources between several users can be taken into account. In a burst-like packet traffic, the same time slots can be divided between different users, if necessary, to make their load efficient. The data rate and performance required by the user and the expected connection time can also affect the selection. If there are only a few packets to be transmitted and, thus, the expected connection time is short, it is not sensible to allocate a long transmission window.

When applying the preferred embodiments of the invention to the EGPRS network, the selection of the transmission window size and the number of TBF connections is made in the packet control unit PCU that can physically reside in SGSN, the base station controller or base station.

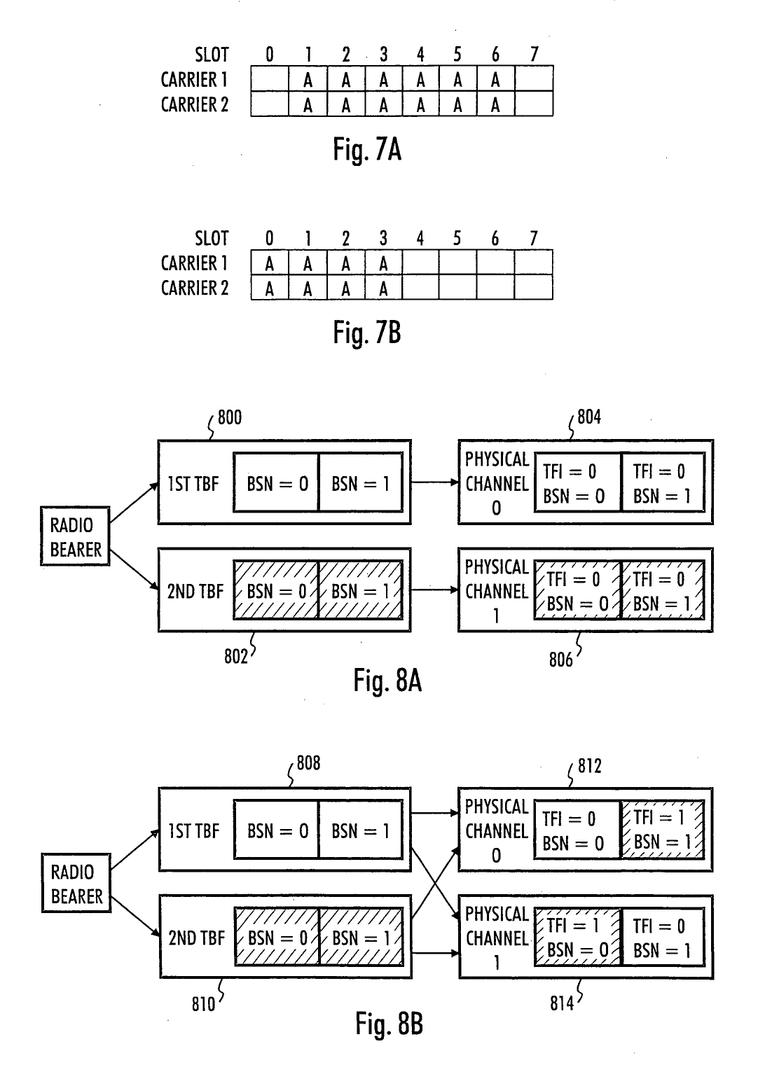

Let us next examine a few examples of selecting TBF connections by means of FIGS. 7A and 7B. Let us assume herein that the transceivers are capable of communicating on more than one frequency and that the used modulation is MCS-9. In the example of FIG. 7A, six time slots on two different frequencies, i.e. time slots 1 to 6 on frequency 1 and time slots 1 to 6 on frequency 2, are allocated to the terminal. Thus, there are altogether 12 time slots. From this and the used modulation follows that the block rate in the allocated 12 time slots is 1200 blocks/s. Therefore, two TBFs need to be reserved.

In the example of FIG. 7B, four time slots on two different frequencies, i.e. time slots 0 to 3 on frequency 1 and time slots 0 to 3 on frequency 2, are allocated to the terminal. Thus, there are altogether 8 time slots and the block rate is 800 blocks/s. In this case, only one TBF is needed.

Let us next examine, how in the case of several TBFs, the resources can be divided between TBFs. The aim is to divide the resources in such a manner that TBFs will not stall.

According to one embodiment, different TBFs have different resources. In this case, the TFI values of TBFs can either be unequal or equal, because TBFs are identified not only according to TFIs but also to the used radio resources. An advantage of this is that the TFI values can be saved (cf. Table 2). The risk of stalling is small, since each TBF has a smaller block rate (blocks/s) than the entire radio bearer.

TABLE 2

| | | | | |
|---|---|---|---|---|
| TFI = 0 | TFI = 1 | TFI = 2 | . . . | TFI = 31 |

| | | |
|---|---|---|
| Physical | 1^{st} TBF | Free for other users or |
| channel 0 | | radio bearers |
| Physical | 2^{nd} TBF | |
| channel 1 | | |

FIG. 8A illustrates this embodiment. The radio bearer comprises two TBFs 800, 802, each having different time slots 804, 806 allocated to them. These TBFs can have the same TFI. The figure shows two RLC blocks for each TBF, having BSN identifiers 0 and 1.

Another embodiment uses dynamic scheduling. Assuming that two TBFs are used, overlapping time slots are allocated to them. During data transmission, the system makes sure that TBFs do not try to use the same time slot simultaneously. If one TBF is close to being stalled, the other TBF can be scheduled, thus achieving an efficient use of the radio resources. An advantage of this embodiment is thus a better flexibility.

Different TBFs thus share either completely or partially a common set of resources. Blocks can be transmitted through any TBF. Each TBF has its own TFI (cf. Table 3).

TABLE 3

| | | | | |
|---|---|---|---|---|
| TFI = 0 | TFI = 1 | TFI = 2 | . . . | TFI = 31 |

| | | | |
|---|---|---|---|
| Physical | 1^{st} TBF | 2^{nd} TBF | Free for other users or |
| channel 0 | | | radio bearers |
| Physical | 1^{st} TBF | 2^{nd} TBF | |
| channel 1 | | | |

FIG. 8B illustrates this embodiment. The radio bearer has two TBFs 808, 810. The TFI of the first TBF is 0 and the TFI of the second TBF is 1. The figure shows two RLC blocks for each TBF, having BSN identifiers 0 and 1. Both TBFs use two time slots 812, 814. In the example of the figure, the first block (TFI=0, BSN=0) of the first TBF is transmitted on channel 812 and the second block (TFI=0, BSN=1) on channel 814. Correspondingly, the first block (TFI=1, BSN=0) of the second TBF is transmitted on channel 814, and the second block (TFI=1, BSN=1) on channel 812.

This embodiment enables multiplexing RLC blocks as follows. TBFs can be sorted according to the TFI values, for instance. The upper-layer blocks (SDU) to be transmitted are multiplexed one after the other to different TBFs, i.e. the first block is transmitted through the first TBF, the second block through the second TBF and so on. The upper-layer blocks are segmented into RLC blocks as usual.

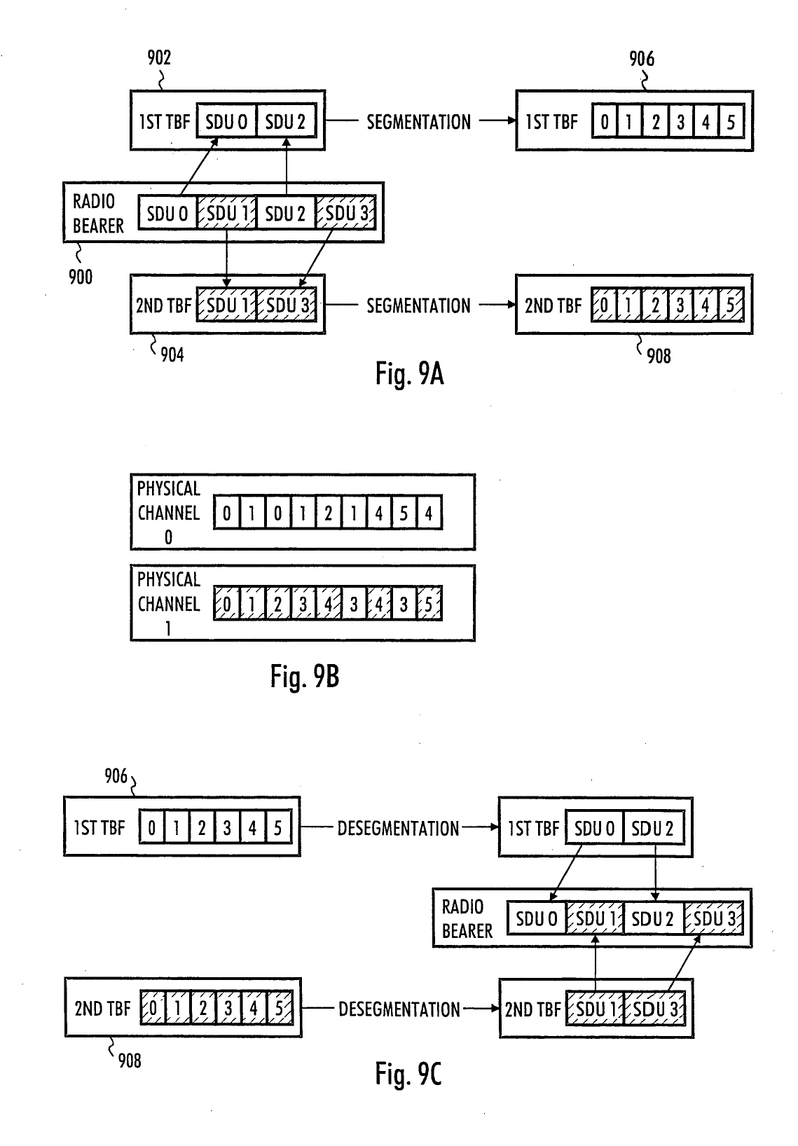

FIGS. 9A and 9B illustrate this alternative by means of an example. In it, the radio bearer 900 comprises two TBFs 902 and 904. The upper-layer blocks SDU0 to SDU3 are divided one after the other to TBFs in such a manner that SDU0 and SDU2 go to the first TBF 902 and SDU1 and SDU3 to the second TBF 904. In TBFs, the upper-layer blocks are segmented into RLC blocks 906, 908, in which case in the example of FIG. 9, each TBF comprises six RLC blocks.

On a physical channel (FIG. 9B), the RLC blocks of the first TBF require more retransmissions than the blocks of the second TBF. This is due to incidental interference on the radio channel or to the fact that the first channel 0 quality is poorer. To make TBFs nearly synchronous, a part of the blocks of the first TBF is transmitted on the second physical channel 1. In the figures, the blocks of the second TBF are hatched.

FIG. 9C shows the operation of a receiver. The RLC blocks 906, 908 of TBFs, after being successfully received, are desegmented back to upper-layer blocks and returned to the correct order on the radio bearer. Because the radio resources used by each TBF can be controlled for instance by scheduling the blocks to different channels as described above, TBFs stay nearly synchronous and the disassembly of the packets to the correct order can be done.

In the described example, the packets blocks were divided one after the other to different TBFs. They can also be divided using some other preset order.

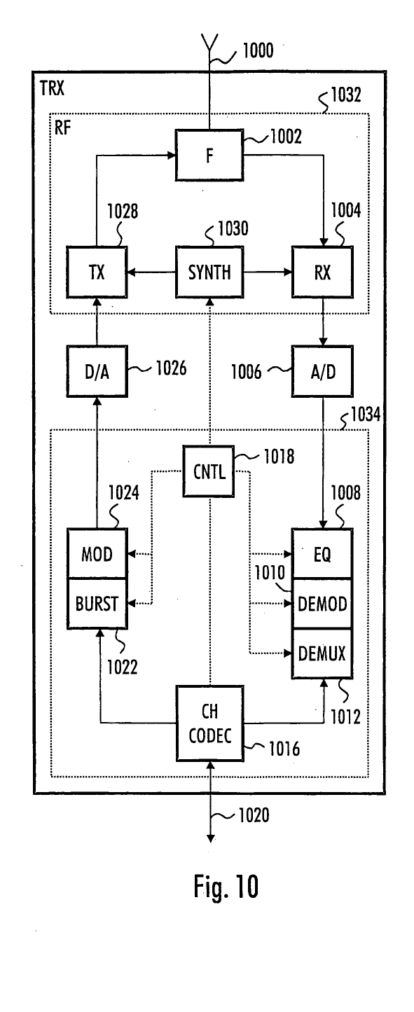

FIG. 10 illustrates the structure of a transceiver of a telecommunications system according to the preferred embodiments of the invention. The device comprises one or more antennas or antenna arrays 1000 for transmitting and receiving signals. From the antenna, the signal is taken to a duplex filter 1002 that separates the signals of the transmission and reception directions from each other. A receiver 1004 comprises a filter that stops frequencies outside the desired frequency band. The signal is then transformed to an intermediate frequency or directly to baseband, and the resulting signal is sampled and quantized in an analogue-to-digital converter 1006. An equalizer 1008 compensates for interference, such as that caused by multipath propagation. A demodulator 1010 separates from the equalized signal a bit stream that is transmitted to a demultiplexer 1012. A demultiplexer 1014 separates the bit stream to its own logical channels. A channel codec 1016 decodes the bit streams of the different logical channels, i.e. decides whether it is signalling data, which is transmitted to a control unit 1018, or other data, which is transmitted 1020 on to other parts of the device. The channel codec 1016 also does error correction. A control unit 1018 controls different units internally. A burst generator 1022 adds a training sequence and tail to the data coming from the channel codec 1016. A modulator 1024 modulates digital signals on a radio-frequency carrier. This function is analogue by nature and requires a digital-to-analogue converter 1026. A transmitter 1028 comprises a filter for limiting the bandwidth. In addition, the transmitter 1028 controls the output power of the transmission. A synthesizer 1030 arranges the required frequencies for different units. A clock in the synthesizer 1030 can be locally controlled. The synthesizer 1030 generates the required frequencies by using a voltage-controlled oscillator, for instance.

In the manner shown in FIG. 10, the structure of the transceiver can yet be divided into radio frequency parts 1032 and a digital signal processor with software 1034. The radio frequency parts 1032 comprise the receiver 1004, transmitter 1028 and synthesizer 1030. The digital signal processor with software 1034 comprises the equalizer 1008, demodulator 1010, demultiplexer 1012, channel codec 1016, control unit 1018, burst generator 1022, and modulator 1024. To convert an analogue radio signal into a digital signal requires an analogue-to-digital converter 1006, and correspondingly, to convert a digital signal into an analogue signal requires a digital-to-analogue converter 1026.

Further, the device can comprise a user interface, such as a display, keyboard, earpiece and microphone. These are, however, not shown in the figure. The control unit 1018 of the device is typically implemented by a microprocessor or separate logic circuits with memory elements and necessary software.

The transceiver according to the preferred embodiments is arranged to transfer data blocks encapsulated in packets on a physical channel with a second transceiver. In a preferred embodiment the channel is divided into time slots.

Even though the invention has been explained in the above with reference to examples in accordance with the accompanying drawings, it is apparent that the invention is not restricted to them but can be modified in many ways within the scope of the inventive idea disclosed in the attached claims.

1. A method for controlling data transmission in a communication system, the method comprising:
transmitting data in packet format between a first and a second transceiver on at least one physical channel,
establishing at least one logical connection for transmitting data blocks between the first and the second transceiver, each logical connection using ARQ error correction and a related transmission window,
selecting the number of logical connections on the basis of the number of data blocks that can be transmitted between the first and the second transceiver per unit of time.

2. A method as claimed in claim 1, further comprising: determining the required size for the transmission window and selecting the number of logical connections on the basis of the required size of the transmission window.

3. A method as claimed in claim 2, wherein if the required size of the transmission window is larger than that allowed for one logical connection, more than one logical connections are selected.

4. A method as claimed in claim 3, wherein when reserving more than one logical connection, the size of the transmission window is selected for each connection in such a manner that each size is at most the largest size of the window allowed for one connection.

5. A method as claimed in claim 3, wherein when reserving more than one logical connection, the size of the transmission window for each connection is selected in such a manner that the total size of the transmission windows is at least the required size of the transmission window.

6. A method as claimed in claim 1, further comprising: using a channel divided into time slots and the number of time slots reserved for transmitting packets affecting the number of logical connections.

7. A method as claimed in claim 6, wherein at least one of the following affects the number of logical connections:
the propagation delay of the signal between the first and the second transceiver,
frequency of acknowledgement transmission,
the ability of the first or the second transceiver to process several logical connections and different transmission window sizes,
the number of connections of different transceivers sharing time slots.

8. A method as claimed in claim 1, wherein time slots are reserved from more than one frequency for the transmission between the first and the second transceiver.

9. A method as claimed in claim 7, wherein the time slots of different frequencies belong to the same logical connection.

10. A method as claimed in claim 7, wherein the time slots of different frequencies belong to different logical connections.

11. A method as claimed in claim 1, wherein each selected logical connection uses its own time slots for packet transmission.

12. A method as claimed in claim 1, wherein the selected logical connections have common time slots for packet transmission.

13. A method as claimed in claim 1, wherein each logical connection has its own error correction.

14. A method as claimed in claim 1, further comprising: selecting more than one logical connection for one radio bearer.

15. A data transmission communication system that comprises a first and a second transceiver, between which data is transmitted in packet format on at least one physical radio channel, and which system is arranged
to establish at least one logical connection for transmitting data blocks between the first and the second transceiver, where each logical connection uses ARQ error correction and a related transmission window, and
to select the number of logical connections on the basis of the number of data blocks that can be transmitted between the first and the second transceiver per unit of time.

16. A system as claimed in claim 15, wherein the system is arranged to determine the required size of the transmission window and to select the number of logical connections on the basis of the required size of the transmission window.

17. A system as claimed in claim 15, wherein the system is arranged to select more than one logical connection, if the required size of the transmission window is larger than that allowed for one logical connection.

18. A system as claimed in claim 17, wherein the system is arranged to select the sizes of the transmission windows for more than one connection in such a manner that when combined they are the required size of the transmission window.

19. A system as claimed in claim 15, wherein the system is arranged to use a channel divided into time slots and take the number of time slots reserved for packet transmission into account when selecting the number of logical connections.

20. A system as claimed in claim 19, wherein the system is arranged to reserve time slots from more than one frequency for data transmission between the first and the second transceiver.

21. A system as claimed in claim 19, wherein the system is arranged to reserve the time slots of different frequencies for the same logical connection.

22. A system as claimed in claim 19, wherein the system is arranged to reserve the time slots of different frequencies for different logical connections.
